(19) United States
(12) Patent Application Publication
(10) Pub. No.: US 2015/0316243 A1
(43) Pub. Date: Nov. 5, 2015

(54) Driver Circuit Integrated LED Module

(71) Applicant: Jianhui Xie, Toronto (CA)

(72) Inventor: Jianhui Xie, Toronto (CA)

(21) Appl. No.: 14/703,864

(22) Filed: May 4, 2015

Related U.S. Application Data
(60) Provisional application No. 61/987,545, filed on May 2, 2014.

(51) Int. Cl. F21V 23/00; H05B 33/08

(52) U.S. Cl. CPC F21V 23/005; H05B 33/0809; F21V 23/001; H05B 33/0845

(57) ABSTRACT

A driver circuit integrated light emitting diode (LED) module is a device that is designed for installation into a conventional lighting fixture and as a replacement for a conventional lighting device such as an incandescent lightbulb. The device features a printed circuit board (PCB) onto which a plurality of LEDs is mounted for illumination. Incoming alternating current (AC) power is converted to usable direct current (DC) power by a rectifier prior to entering the PCB. A control module is used to regulate the current through the plurality of LEDs, allowing the device to be utilized in conjunction with a dimmer switch or similar device. The device is connected to mains electricity and/or to an external electronic device via an at least one electrical connector cable. Flickering is prevented by a uniform power regulating capacitor. The device is installed into an existing lighting fixture via an at least one mounting magnet.

The current application claims a priority to the U.S. Provisional Patent application Ser. No. 61/987,545 filed on May 2, 2014. The current application is filed on May 4, 2015 while May 2, 2015 was on a weekend.

### FIELD OF THE INVENTION

The present invention relates generally to a solid-state lighting device. More specifically, the present invention is a driver circuit integrated light-emitting diode (LED) module that is designed to slot into a lighting fixture and serve as a replacement for traditional lighting devices such as incandescent lightbulbs.

### BACKGROUND OF THE INVENTION

Solid-state lighting devices are lighting devices that utilize semiconductor light-emitting diodes (LEDs) for illumination in lieu of traditional electrical filaments, plasma, and gas used in incandescent lightbulbs and compact fluorescent lamps (CFLs). Despite their high initial cost, LED lighting devices are considerably more efficient than traditional lighting devices and are often favored due to their reduced power requirements. In addition to their efficiency, LED lighting devices are not subject to substantial wear and tear over time and as such, do not often require replacement. LED lighting devices also do not require a warmup period in order to achieve full brightness as is often required by many conventional lighting devices. LED lighting devices are available in a wide variety of forms ranging from simple LED strips to more complex LED arrays. A typical LED lighting device generally comprises a printed circuit board (PCB) onto which LED chips are arranged in order to provide illumination. LED chips require direct current (DC) electrical power in order to operate and, as such, an LED lighting device generally comprises a rectifier for converting alternating current (AC) electrical power to DC electrical power.

The present invention is a driver circuit integrated LED module that may be installed into a lighting fixture similar to the manner in which a traditional lighting device such as an incandescent lightbulb. The present invention is electrically connected to AC electrical power that is converted to DC electrical power in order to illuminate the LEDs.

### BRIEF DESCRIPTION OF THE DRAWINGS

FIG. 1 is a top perspective view of the present invention.

FIG. 2 is a bottom perspective view of the present invention.

FIG. 3 is a schematic diagram of the electronic components of the present invention.

FIG. 4 is a top exploded perspective view of the present invention.

FIG. 5 is a bottom exploded perspective view of the present invention.

FIG. 6 is a top perspective view of the present invention with the at least one electrical connector cable being positioned through the at least one cable routing slot.

FIG. 7 is a bottom perspective view of the present invention with the at least one electrical connector cable being positioned through the at least one cable routing slot.

FIG. 8 is a side view of the present invention with a lighting fixture.

FIG. 9 is a bottom exploded perspective view of the present invention with a lighting fixture.

### DETAIL DESCRIPTIONS OF THE INVENTION

All illustrations of the drawings are for the purpose of describing selected versions of the present invention and are not intended to limit the scope of the present invention.

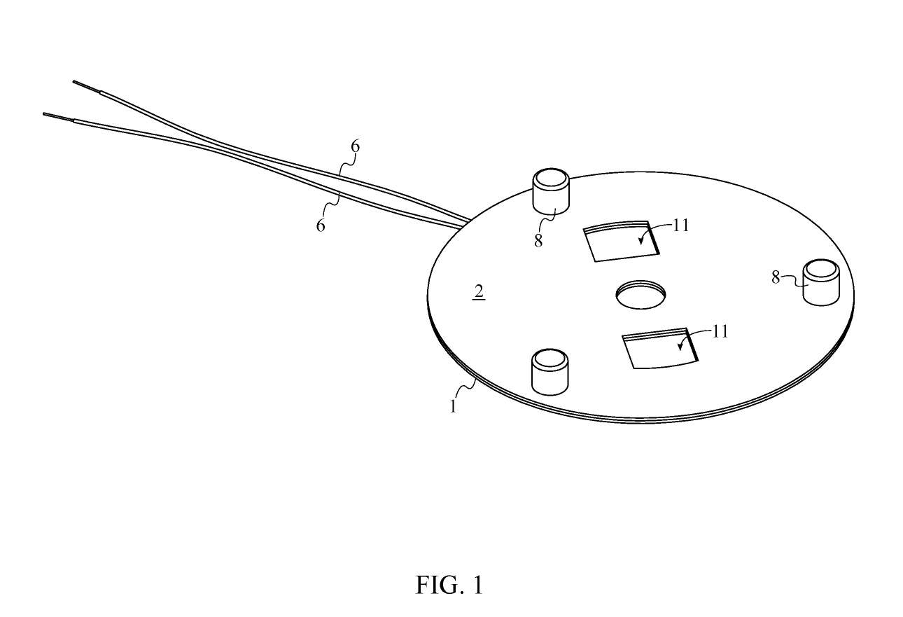

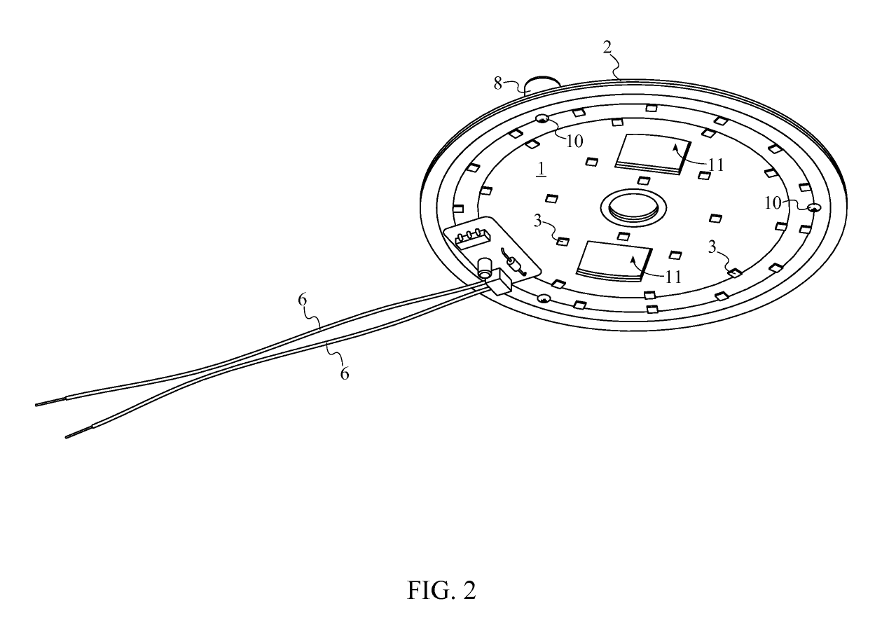

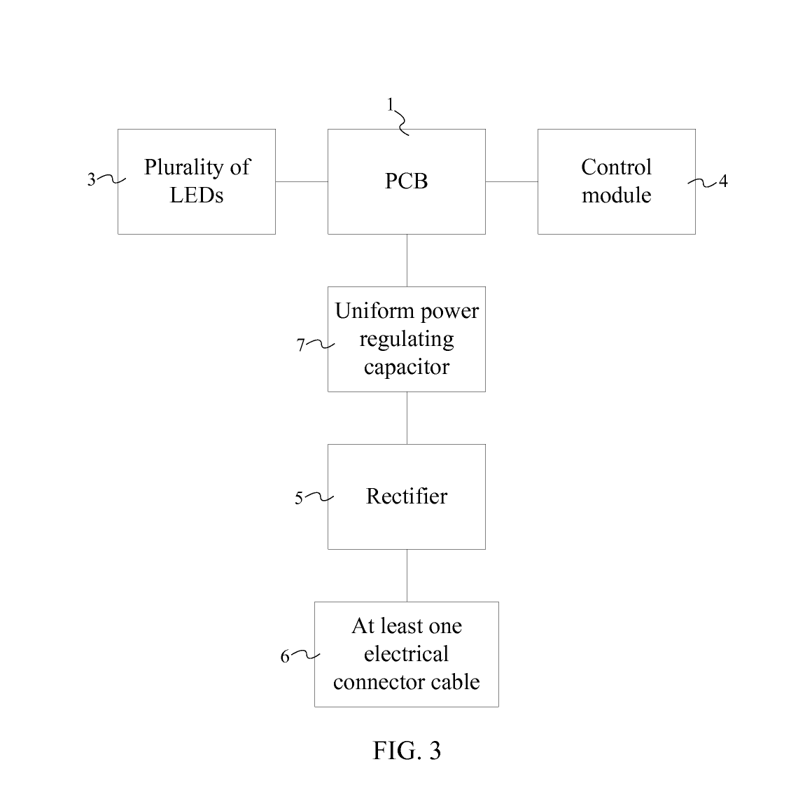

The present invention is a driver circuit integrated light-emitting diode (LED) module that is designed to slot into a lighting fixture and serve as a replacement for a conventional lighting device such as an incandescent lightbulb. With reference to FIGS. 1-3, the present invention comprises a printed circuit board 1 (PCB), a fixture adapter base 2, a plurality of LEDs 3, a control module 4, a rectifier 5, and an at least one electrical connector cable 6.

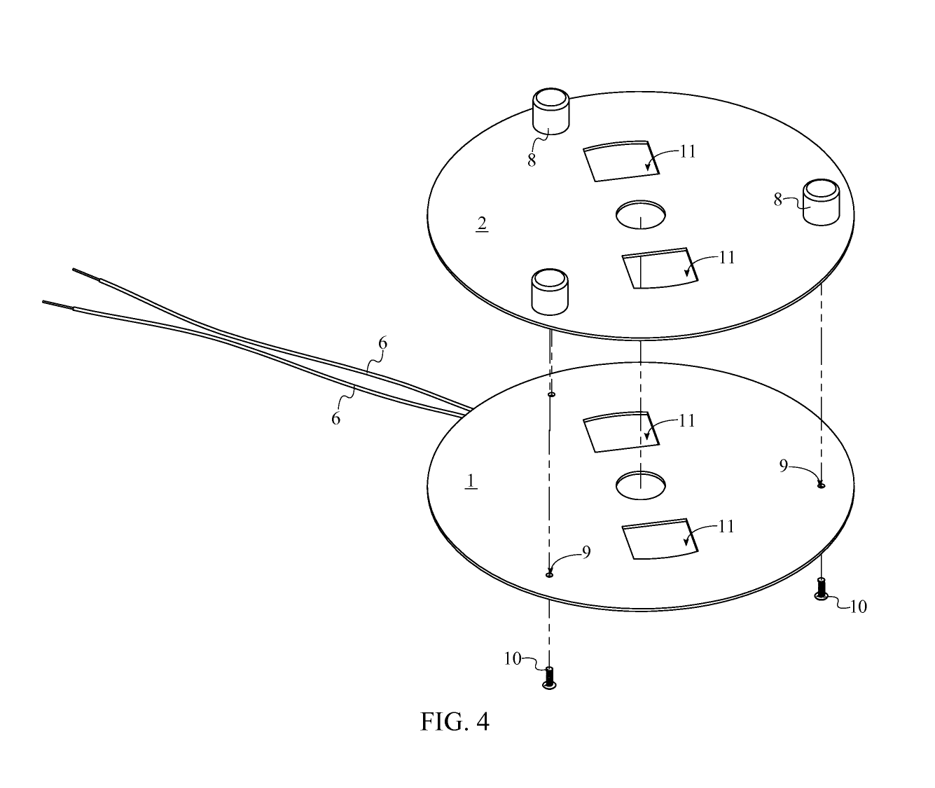

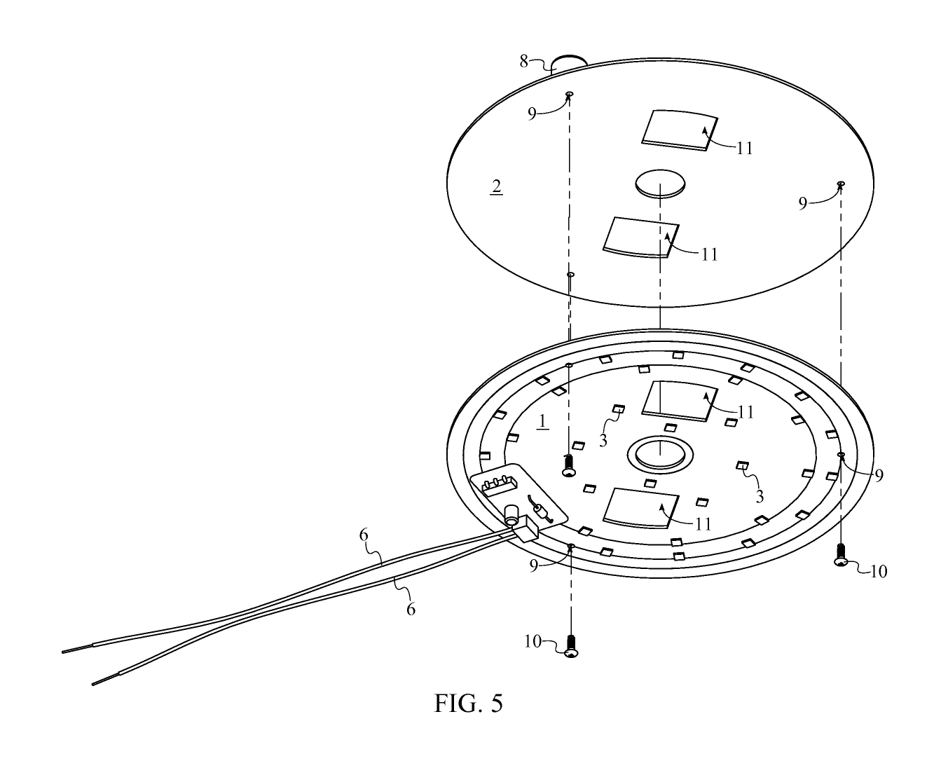

The PCB 1 is the structural base that provides physical support to the electronic components of the present invention as well as electronically connects the electronic components of the present invention to each other. In the preferred embodiment of the present invention, the fixture adapter base 2 is a rigid structure that provides structural support to the PCB 1 and additionally is configured to slot into an existing lighting fixture. As such, the physical design of the fixture adapter base 2 may vary across embodiments of the present invention in order to accommodate various different styles of lighting fixtures. As shown in FIG. 4 and FIG. 5, the PCB 1 is superimposed upon the fixture adapter base 2 to allow the fixture adapter base 2 to support the PCB 1. Additionally, the PCB 1 is perimetrically delineated by the fixture adapter base 2, ensuring that the PCB 1 and the fixture adapter base 2 are of the same size, shape, and overall physical design. In the preferred embodiment of the present invention, the PCB 1 features a conductive pattern of tracks and pads that are utilized to connect the electronic components of the present invention to the PCB 1. In the preferred embodiment of the present invention, the PCB 1 may be composed of a material such as, but not limited, to aluminum or fiberglass.

Again with reference to FIGS. 1-3, the plurality of LEDs 3 is the lighting source of the present invention and is capable of providing illumination to an area in which the present invention is installed. The control module 4 is the electronic component that allows for a degree of control over the behavior of the plurality of LEDs 3. For example, the control module 4 allows the present invention to be utilized in conjunction with a dimmer switch. The control module 4 is able to regulate the current through the plurality of LEDs 3 in order to increase or decrease the brightness of the plurality of LEDs 3. The plurality of LEDs 3 is electronically connected to the control module 4 through the PCB 1 in order to allow the control module 4 to regulate the behavior of the plurality of LEDs 3. The plurality of LEDs 3 is distributed across the PCB 1, allowing for even illumination along the surface of the PCB 1. However, the present invention is not limited with respect to the specific arrangement of the plurality of LEDs 3. The plurality of LEDs 3 may be electrically connected in series, parallel, or a combination of series and parallel. Additionally, the plurality of LEDs 3 may be bonded to the PCB 1 via means including, but not limited to, conductive adhesive, ultrasonic bonding, or solder. The plurality of LEDs 3 is able to provide similar lumens-worth of illumination relative to traditional lighting device such as incandescent lightbulbs.

The at least one electrical connector cable 6 allows the present invention to be connected to an external power source such as alternating current (AC) mains electricity to power the electronic components of the present invention. However, the plurality of LEDs 3 requires direct current (DC) electrical power in order to operate. As such, the rectifier 5 is able to convert the AC electrical power into DC electrical power that is suitable for driving the plurality of LEDs 3. The PCB 1 is electrically connected to the at least one electrical connector cable 6 through the rectifier 5. This ensures that the electrical current flowing into the PCB 1 is DC electrical power that is usable to operate the plurality of LEDs 3. The at least one electrical connector cable 6 may comprise a terminal block, terminal strip with input wire, or similar interface for connecting the present invention to mains electricity or another external destination.

The present invention further comprises a uniform power regulating capacitor 7. The DC electrical power flowing from the rectifier 5 to the PCB 1 may be unsteady and pulsate, resulting in flickering of the plurality of LEDs 3. The uniform power regulating capacitor 7 filters out the pulses and creates a more steady DC electrical power entering the PCB 1 in order to eliminate the flickering caused by unsteady DC electrical power. The uniform power regulating capacitor 7 is electrically connected between the rectifier 5 and the PCB 1, allowing the unsteady DC electrical power converted from AC electrical power by the rectifier 5 to become steadier before flowing into the PCB 1. The present invention may additionally feature a protective housing cover for safely shielding the high voltage electronic components of the present invention.

In the preferred embodiment of the present invention, the present invention is magnetically installed into a lighting fixture, which allows the present invention to be installed without the use of tools or fasteners. As such, in its preferred embodiment, the present invention further comprises an at least one mounting magnet 8, which can be a single magnet but more typically is multiple magnets. The at least one mounting magnet 8 is distributed across the fixture adapter base 2 allowing the at least one mounting magnet 8 to secure the fixture adapter base 2 in place within the lighting fixture. The at least one mounting magnet 8 is connected onto the fixture adapter base 2, opposite to the PCB 1. Because the PCB 1 is superimposed upon the fixture adapter base 2, the at least one mounting magnet 8 is able to hold the PCB 1 in place as well in addition to the fixture adapter base 2. The at least one mounting magnet 8 may be connected to the fixture adapter base 2 via adhesive or similar means.

As shown in FIG. 4 and FIG. 5, in its preferred embodiment, the present invention further comprises an at least one fastener hole 9 and an at least one fastener 10. The at least one fastener hole 9 and the at least one fastener 10 are utilized to secure the PCB 1 to the fixture adapter base 2. The at least one fastener hole 9 is concentrically aligned with the at least one mounting magnet 8 and additionally traverses through the PCB 1 and through the fixture adapter base 2. Additionally, the at least one fastener hole 9 traverses into the at least one mounting magnet 8. As such, the at least one fastener 10 may be inserted through the PCB 1, the fixture adapter base 2, and into the at least one mounting magnet 8, securing the PCB 1 to the fixture adapter base 2 and allowing the at least one fastener 10 to be secured into the at least one mounting magnet 8. The at least one fastener 10 is removably attached to the PCB 1 through the at least one fastener hole 9 and is removably attached to the fixture adapter base 2 through the at least one fastener hole 9 as well. This allows the user to separate the PCB 1 from the fixture adapter base 2 if needed.

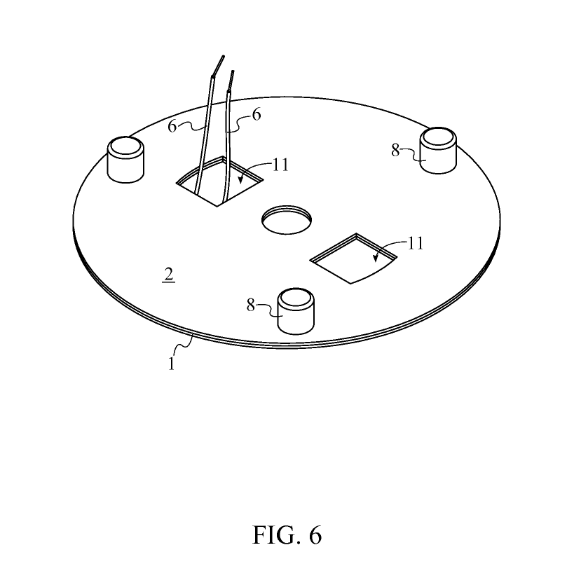

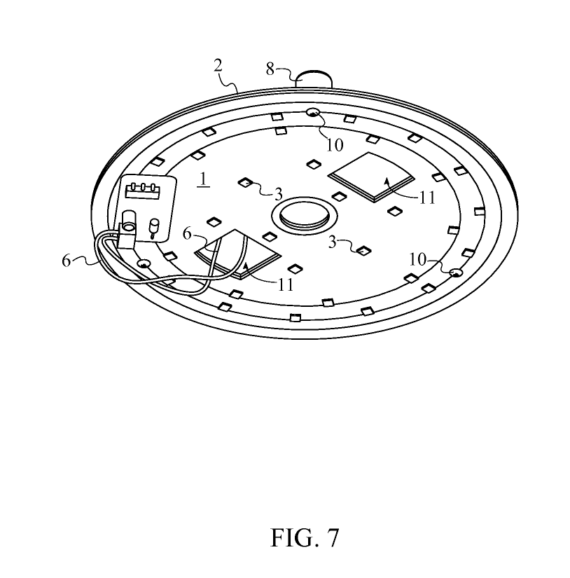

With reference to FIG. 6 and FIG. 7, the present invention further comprises an at least one cable routing slot 11. The at least one cable routing slot 11 is a slot through which the user is able to route the at least one electrical connector cable 6. This is particularly useful if the lighting fixture into which the present invention is installed is not conducive for connecting the at least one electrical connector cable 6 to the desired destination (e.g. the lighting fixture is cramped). The at least one cable routing slot 11 traverses normal to and through the PCB 1 and the fixture adapter base 2. This allows the at least one electrical connector cable 6 to be routed through the PCB 1 and the fixture adapter base 2 in order to reach a desired destination. The at least one electrical connector cable 6 is positioned through the at least one cable routing slot 11 in order to bypass cramped or similar unaccommodating light fixtures. The plurality of LEDs 3 is positioned around the at least one cable routing slot 11 and as such, the at least one cable routing slot 11 does not compromise the level of illumination provided by the plurality of LEDs 3.

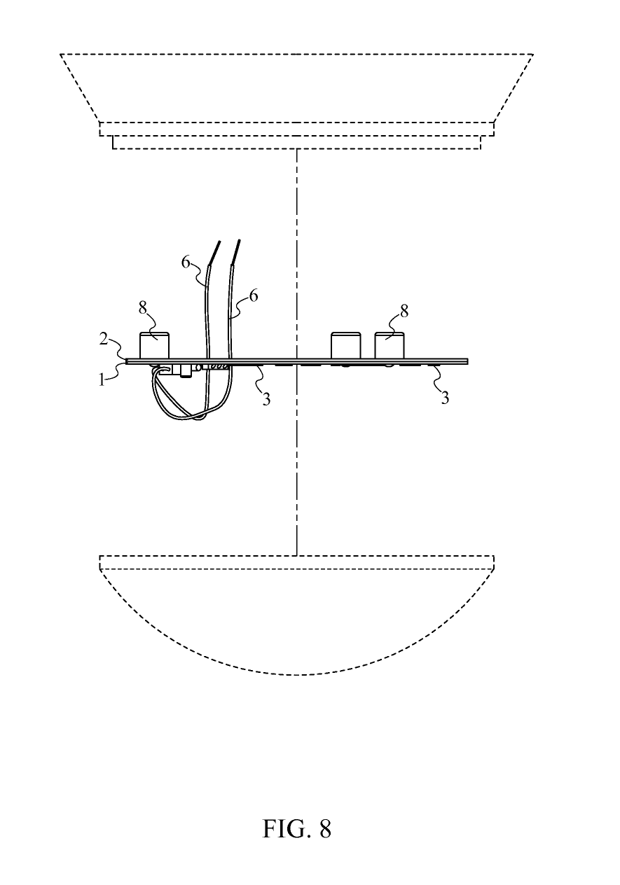

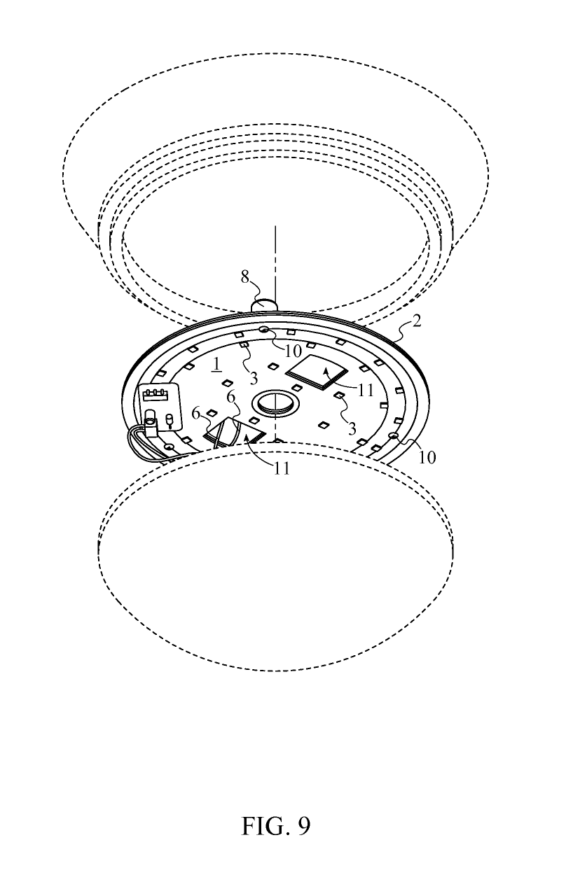

As shown in FIG. 8 and FIG. 9, the present invention may be installed into a lighting fixture. In its preferred embodiment, the present invention is magnetically installed into a lighting fixture via the at least one mounting magnet 8. The at least one electrical connector cable 6 is then connected to mains electricity and any other external device such as, but not limited to, a dimmer switch. The center hole traversing through the center of the PCB 1 and the fixture adapter base 2 may be used to mount a cover or similar object over the lighting fixture. For example, a fastener that is secured to both the cover and the lighting fixture may be inserted through the center hole in order to secure the cover in place.

Although the present invention has been explained in relation to its preferred embodiment, it is understood that many other possible modifications and variations can be made without departing from the spirit and scope of the present invention as hereinafter claimed.

What is claimed is:

1. A driver circuit integrated LED module comprises:
a printed circuit board (PCB);
a fixture adapter base;
a plurality of light-emitting diodes (LEDs);
a control module;
a rectifier;
an at least one electrical connector cable;
the PCB being superimposed upon the fixture adapter base;
the PCB being perimetrically delineated by the fixture adapter base;
the plurality of LEDs being distributed across the PCB;
the plurality of LEDs being electronically connected to the control module through the PCB; and
the PCB being electrically connected to the at least one electrical connector cable through the rectifier.

2. The driver circuit integrated LED module as claimed in claim 1 further comprises:
a uniform power regulating capacitor; and
the uniform power regulating capacitor being electrically connected between the rectifier and the PCB.

3. The driver circuit integrated LED module as claimed in claim 1 further comprises:
an at least one mounting magnet;
the at least one mounting magnet being distributed across the fixture adapter base; and
the at least one mounting magnet being connected onto the fixture adapter base, opposite to the PCB.

4. The driver circuit integrated LED module as claimed in claim 3 further comprises:
an at least one fastener hole;
an at least one fastener;
the at least one fastener hole being concentrically aligned with the at least one mounting magnet;
the at least one fastener hole traversing through the PCB and through the fixture adapter base;
the at least one fastener hole traversing into the at least one mounting magnet;
the at least one fastener being removably attached to the PCB through the at least one fastener hole; and
the at least one fastener being removably attached to the fixture adapter base through the at least one fastener hole.

5. The driver circuit integrated LED module as claimed in claim 1 further comprises:
an at least one cable routing slot;
the at least one cable routing slot traversing normal to and through the PCB and the fixture adapter base; and
the plurality of LEDs being positioned around the at least one cable routing slot.

6. The driver circuit integrated LED module as claimed in claim 5 further comprises:
the at least one at least one electrical connector cable being positioned through the at least one cable routing slot.

7. A driver circuit integrated LED module comprises:
a printed circuit board (PCB);
a fixture adapter base;
a plurality of light-emitting diodes (LEDs);
a control module;
a rectifier;
an at least one electrical connector cable;
a uniform power regulating capacitor;
the PCB being superimposed upon the fixture adapter base;
the PCB being perimetrically delineated by the fixture adapter base;
the plurality of LEDs being distributed across the PCB;
the plurality of LEDs being electronically connected to the control module through the PCB;
the PCB being electrically connected to the at least one electrical connector cable through the rectifier; and
the uniform power regulating capacitor being electrically connected between the rectifier and the PCB.

8. The driver circuit integrated LED module as claimed in claim 7 further comprises:
an at least one mounting magnet;
the at least one mounting magnet being distributed across the fixture adapter base; and
the at least one mounting magnet being connected onto the fixture adapter base, opposite to the PCB.

9. The driver circuit integrated LED module as claimed in claim 7 further comprises:
an at least one fastener hole;
an at least one fastener;
the at least one fastener hole being concentrically aligned with the at least one mounting magnet;
the at least one fastener hole traversing through the PCB and through the fixture adapter base;
the at least one fastener hole traversing into the at least one mounting magnet;
the at least one fastener being removably attached to the PCB through the at least one fastener hole; and
the at least one fastener being removably attached to the fixture adapter base through the at least one fastener hole.

10. The driver circuit integrated LED module as claimed in claim 7 further comprises:
an at least one cable routing slot;
the at least one cable routing slot traversing normal to and through the PCB and the fixture adapter base; and
the plurality of LEDs being positioned around the at least one cable routing slot.

11. The driver circuit integrated LED module as claimed in claim 10 further comprises:
the at least one at least one electrical connector cable being positioned through the at least one cable routing slot.

12. A driver circuit integrated LED module comprises:
a printed circuit board (PCB);
a fixture adapter base;
a plurality of light-emitting diodes (LEDs);
a control module;
a rectifier;
an at least one electrical connector cable;
a uniform power regulating capacitor;
an at least one mounting magnet;
the PCB being superimposed upon the fixture adapter base;
the PCB being perimetrically delineated by the fixture adapter base;
the plurality of LEDs being distributed across the PCB;
the plurality of LEDs being electronically connected to the control module through the PCB;
the PCB being electrically connected to the at least one electrical connector cable through the rectifier;
the uniform power regulating capacitor being electrically connected between the rectifier and the PCB;
the at least one mounting magnet being distributed across the fixture adapter base; and
the at least one mounting magnet being connected onto the fixture adapter base, opposite to the PCB.

13. The driver circuit integrated LED module as claimed in claim 12 further comprises:
an at least one fastener hole;
an at least one fastener;
the at least one fastener hole being concentrically aligned with the at least one mounting magnet;
the at least one fastener hole traversing through the PCB and through the fixture adapter base;
the at least one fastener hole traversing into the at least one mounting magnet;
the at least one fastener being removably attached to the PCB through the at least one fastener hole; and
the at least one fastener being removably attached to the fixture adapter base through the at least one fastener hole.

14. The driver circuit integrated LED module as claimed in claim 12 further comprises:
an at least one cable routing slot;
the at least one cable routing slot traversing normal to and through the PCB and the fixture adapter base; and
the plurality of LEDs being positioned around the at least one cable routing slot.

15. The driver circuit integrated LED module as claimed in claim 14 further comprises:
the at least one at least one electrical connector cable being positioned through the at least one cable routing slot.
